(19) United States
(12) Patent Application Publication
(10) Pub. No.: US 2004/0141619 A1
(43) Pub. Date: Jul. 22, 2004

(54) Method of generating a left modified and a right modified audio signal for a stereo system

(76) Inventor: Daniel Willem Elisabeth Schobben, Eindhoven (NL)

Correspondence Address: U S Philips Corporation, Intellectual Property Department, PO Box 3001, Briarcliff Manor, NY, 10150, US

(21) Appl. No.: 10/478,739

(22) PCT Filed: May 24, 2002
(86) PCT No.: PCT/IB02/01921

(30) Foreign Application Priority Data
May 29, 2001 (EP) 01202031.9

(51) Int. Cl. H04R 5/00; H04R 5/02

(52) U.S. Cl. 381/1; 381/309

(57) ABSTRACT

The invention relates to a method of generating a left modified and a right modified audio signal for a stereo system from multichannel audio signals (X_{L}, X_{R}, X_{LS}, X_{RS}, and X_{C}) with a left and a right channel and at least one further audio channel. According to the invention, the signal of the channel of highest energy is modified in a filter (1) with a transformation function in a first parallel branch (2) and is modified in a second filter (6) with a reverberation function in a second parallel branch (5), whereupon the modified signals are joined together in a summation unit (8).

The invention relates to a method of generating a left modified and a right modified audio signal for a stereo system from multichannel audio signals having a left and a right channel and at least one further audio channel.

U.S. Pat. No. 5,638,451 discloses a transmission and storage method for audio signals. To achieve a compatibility between a multichannel system and stereo technique, a multichannel source coder is provided for coding multichannel audio signals. Signals from additional audio channels of the multichannel audio system are added to the left and right basic signals of the multichannel audio system, such that two modified stereo signals are created for reproduction via a stereo system.

The invention has for its object to provide a simple method for reproducing multichannel audio signals in a stereo system. In particular, a simple method and a simple circuit for reproducing the multichannel audio sound via a headphone is to be indicated.

The object is achieved by means of the characterizing features of claim 1.

According to the invention, the signal of the channel of highest energy is modified in a first parallel branch in a filter with a transformation function and in a second parallel branch in a second filter with a reverberation function, whereupon the modified signals are joined together in a summation unit. These two filters together are identical to a long filter which exactly imitates the transformation function of the central loudspeaker to the left ear. It is only the signal of highest energy which is taken into account in the generation of sound. Filters are required for one channel only.

In a simple manner, the signal of the channel of highest energy is joined together with other multichannel audio signals in a second summation unit before the modification with the transformation function. Since the low-energy signals are drowned out by the high-energy signal, the former may be passed through the same filter.

Advantageously, the signal of the channel of highest energy is joined together with other multichannel audio signals in a third summation unit before the modification with the reverberation function. The filter for the channel of highest energy may again be used for the low-energy signals because of the drowning-out effect, also for the reverberation function.

Advantageously, the transformation function is the head-related transfer function (HRTF) for the channel of highest energy. The person-related transfer function may be combined with the transformation.

In a simple manner, the reverberation function is the reverberation function of the channel of highest energy. Filters are saved in this manner.

In a simple manner, the second parallel branch comprises a time delay element for providing the reverberation with a time delay.

Advantageously, the signals of lower energy are modified by a coarse transformation function before the second summation unit.

Advantageously, the coarse transformation function is the head-related transfer function of the respective channel. The generation of the associated individual transformation function can be realized with a small calculation or computer effort.

The invention is based on the assumption that the requirements imposed on the accuracy of sound reproduction should be very stringent if only few channels are used, in other words, each sound is to be reproduced via a virtual loudspeaker. Five-channel DVD signals are reproduced via a five-channel loudspeaker set or by means of five virtual loudspeakers through a set of headphones. DVD is short for digital versatile disc. If five channels of a DVD arrangement are used, the requirements imposed on the quality of the generation of the signals for the sound sources involved may be appreciably less because of the reception through (no more than) two ears. When five virtual loudspeakers are simulated through headphones, simple approximations require 5×½ times as much processing time as virtual stereo through headphones. The calculation capacity is only fully loaded when the audio device is set for the 5-channel mode. The availability of such a capacity, i.e. the use and incorporation of processors of high power, is comparatively expensive and not very useful if such an audio device is mostly used merely for a virtual stereo reproduction through headphones.

A saving is made in calculation capacity through a simplification of those filters which are used for generating several virtual loudspeakers through headphones. Five virtual loudspeakers are simulated in a DVD arrangement. Filters of better quality are utilized when virtual stereo is generated through headphones. The resulting calculation capacity for five virtual DVD loudspeakers is comparable to that of a virtual stereo headphone system, which means that the calculation capacity is utilized to the same extent in both cases.

The filters used for generating virtual loudspeakers through headphones may be subdivided into various segments of decreasing importance. The subdivision of the segments for the sound reproduction takes place in dependence on the number of virtual loudspeakers to be generated. This leads to a constant calculation capacity in combination with a substantially constant perceivable quality. A coarse construction of the filters leads to a saving in calculation capacity.

Embodiments of the invention will be explained in more detail below for better understanding, with reference to the drawing, in which:

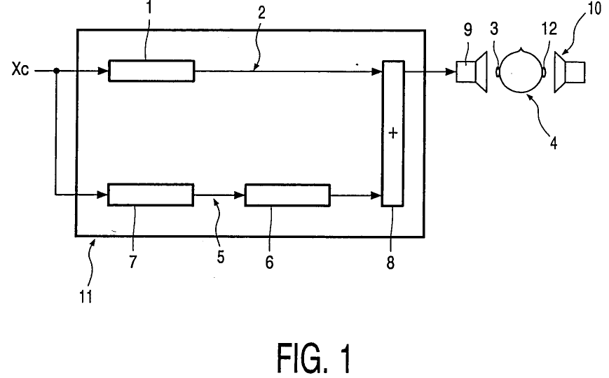

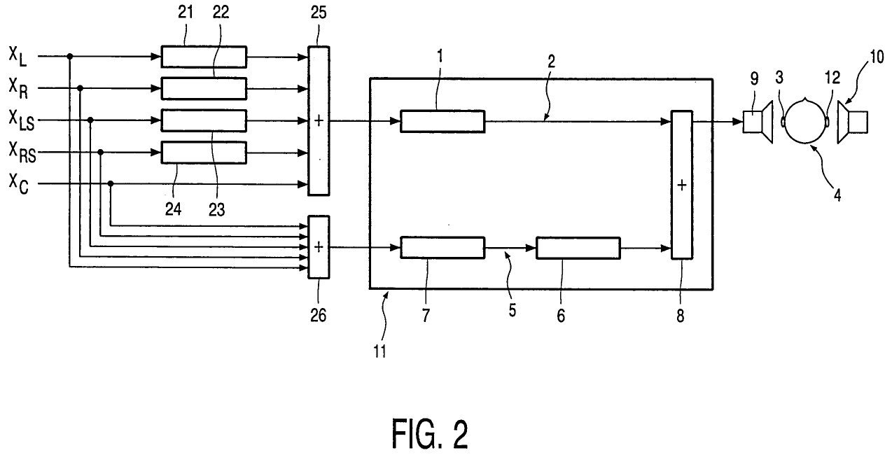

FIG. 1 shows a circuit for sound generation at a left ear by means of an audio signal from a channel of high energy, and FIG. 2 shows a circuit for sound generation at a left ear by means of several multichannel audio signals.

FIG. 1 shows a short filter 1 in a parallel branch 2, which filter incorporates the head-related transfer function for a signal Xc of a central channel to a left ear 3 of a person 4. In a second parallel branch 5, a long filter 6 is arranged by means of which a reverberation can be generated. A time delay element 7 is also incorporated in the parallel branch 5, such that the reverberation arrives later than the HRTF. An adder 8, denoted summation unit hereinafter, adds the signals coming from the filters 1 and 6 and applies the added signal to a left loudspeaker 9 of a set of headphones 10. The two filters 1 and 6, the time delay element 7, and the summation unit 8 are identical to a long filter 11 which exactly simulates the transformation function of a central loudspeaker for the left ear 3. The sound generation for a right ear 12 may be derived in an analogous manner.

FIG. 2 shows a DVD sound generation with five channels with the same filter 11. The filter 11 may alternatively be replaced by a processor with a suitable software. Signals X_{L}, X_{R}, X_{LS} and X_{RS} are applied to a summation unit 25 via respective filters 21, 22, 23 and 24. The filtered signals X_{L}, X_{R}, X_{LS} and X_{RS} and the unfiltered signal X_{C} are added in the summation unit 25 and provided to the filter 1. The filters 21 to 24 for the left, right, left surround, and right surround sound channels are realized with low technical expenditure and are of very simple construction. The filters 21 to 24 are connected in series with the filter 1 realized with high technical expenditure for the central channel, which latter filter supplies a high quality. The virtual left, right, left surround, and right surround loudspeakers have thus been added without a significant increase in complexity. All virtual loudspeakers are added in a further adder 26 and share the reverberation filter 6 of the central channel. This does not detract from the perceivable quality because the reverberation hardly contains any directional information, and the central channel drowns out the other channels because it typically contains very much energy. The filters 21 to 24 merely contain a time delay and a modification as to sound strength or a spectral change and coarsely resemble the original HRTFs. An approximate resemblance is sufficient because the central channel drowns out the other channels. It should be noted that the generation of the central channel in this ambience is exact, and the total complexity resembles that of the one-channel realization of FIG. 1. This method may be implemented to advantage with digitized signals. All appliances used, in particular the filters and the summation units, are of a digital construction and may thus process the digital signals in a simple manner.

Simple measurements render it possible to determine the channel of highest energy at any moment, and the corresponding HRTF may be selected in dependence on this channel. The implementation may be dynamically modified in dependence on the energy levels of the individual channels. In this manner the channel of highest energy may be reproduced with the highest quality at each and every moment.

The circuit may be comprised in portable DVD playback devices, but alternatively in all other audio devices with a headphone output and a multichannel audio system.

List of Reference Numerals

1 short filter

2 first parallel branch

3 left ear

4 person

5 second parallel branch

6 long filter

7 time delay element

8 adder (summation unit)

9 left loudspeaker

10 headphones

11 filter

12 right ear

21 simple filter

22 simple filter

23 simple filter

24 simple filter

25 adder

26 adder

1. A method of generating a left modified and a right modified audio signal for a stereo system from multichannel audio signals (X_{L}, X_{R}, X_{LS}, X_{RS}, and X_{C}) having a left and a right channel and at least one further audio channel, characterized in that the signal of the channel of highest energy is modified in a first parallel branch (2) in a filter (1) with a transformation function and in a second parallel branch (5) in a second filter (6) with a reverberation function, whereupon the modified signals are joined together in a summation unit (8).

2. A method as claimed in claim 1, characterized in that the signal of the channel (X_{C}) of highest energy is joined together with other multichannel audio signals (X_{L}, X_{R}, X_{LS}, and X_{RS}) in a second summation unit (25) before the modification with the transformation function.

3. A method as claimed in claim 1, characterized in that the signal of the channel of highest energy is joined together with other multichannel audio signals (X_{L}, X_{R}, X_{LS}, and X_{RS}) in a third summation unit (26) before the modification with the reverberation function.

4. A method as claimed in claim 1 and/or 2, characterized in that the transformation function is the head-related transfer function (HRTF) for the channel of highest energy.

5. A method as claimed in claim 1 and/or 3, characterized in that the reverberation function is the reverberation function of the channel of highest energy.

6. A method as claimed in claim 1, 3, and/or 5, characterized in that the second parallel branch (5) comprises a time delay element (7) for providing the reverberation with a time delay.

7. A method as claimed in any one or several of the preceding claims 1 to 6, characterized in that the signals of lower energy are modified by a coarse transformation function before the second summation unit (25).

8. A method as claimed in claim 6, characterized in that the coarse transformation function is the head-related transfer function of the respective channel.
